(19) United States
(12) Patent Application Publication
(10) Pub. No.: US 2007/0063083 A1
(43) Pub. Date: Mar. 22, 2007

(54) Device for dispensing small amounts of a material

(76) Inventor: Volker Wagner, Hamburg (DE)

Correspondence Address: MEREK, BLACKMON & VOORHEES, LLC, 673 S. WASHINGTON ST, ALEXANDRIA, VA, 22314, US

(21) Appl. No.: 10/553,477

(22) PCT Filed: Jan. 26, 2005
(86) PCT No.: PCT/EP05/00744

§ 371 Date: Nov. 13, 2006

(30) Foreign Application Priority Data
Jan. 28, 2004 (DE) 20 2004 001 313.4

(51) Int. Cl. B02C 19/00

(52) U.S. Cl. 241/277

(57) ABSTRACT

The invention relates to a device, for the dosed dispensing of small amounts of a material, comprising a housing for the material and an opening to the exterior, for the dispensing of the material. The material is itself embodied as a housing and has the form of a block with such a size as to be at least partly gripped by the hand of a user, or which may be held in the hand. The block is embodied with a rigid outer surface and an actuator may be introduced and operated through the opening in the block, which releases desired amounts of the material from inside the block or from the region surrounding the opening, by means of a scraping, digging or frictional interaction.

The invention refers to a device for the metered delivery of small amounts of a substance, comprising a case for the substance and an outwardly leading opening for the delivery of the substance.

The present invention is in particular directed to such a device, by means of which table salt can be delivered. It can also be a table salt dispenser.

Table salt dispensers consist basically of a firm case with one or more openings such that the granular table salt disposed inside of the case can be delivered through the openings. Table salt is packaged or filled in cases after the preparation, brought to sale and reaches the consumer from there. The consumer can use the case as a salt dispenser, he/she can put the salt into a different case or dispose of the case, after it has been emptied.

This is the point where the invention starts and intends to implement a device of the type indicated above in new shape and of a different application. In particular, a device shall be provided in connection with the use of table salt.

This is achieved by a device for the metered delivery of small amounts of a substance comprising a case for the substance and an outwardly leading opening for the delivery of the substance.

In the present invention, a case in the usual sense for the material to be delivered is not provided. The material itself assumes in the indicated form the task of the case, which presupposes that the substance can be brought into a compact form or initially has this form. Table salt, which is extracted in the mine, comprises this block form from the start such that in connection with the use of the device according to the invention a series of operations in the preparation are not required. However, the naturally found form of the salt crystal block can also be brought into a different shape, wherein for reasons of the better handling and also of aesthetics the spherical or egg shape are of special importance for the present invention.

It lies within the scope of the invention, to bring other substances into the desired firm shape of a block as well such that they assume the function of a case. For example, sugar crystals can brought into a spherical shape such that by means of a suitable tool such a block can be gradually transferred into the desired amount of sugar able to trickle. It is also envisaged to bring mixtures of spices, roots and such like into the corresponding form.

A further feature substantial for the present invention is an opening leading into the inner area of the block. In the initial use of the device this comprises a bore of small depth, which is formed such though that the provided tool can be is inserted or introduced here. In the course of use this cavity is increasingly enlarged, and that to the extent that finally the block loses its initial shape and is even destroyed. The residual parts, which remain then, cannot be suitable for consumption any more and must also not be used for food.

The part of the present invention designated as actor can be formed in the most simple form as a grater, file, milling cutter or rasp. A rasp, for example, is inserted into the opening of the block and by suitable movements of the rasp the material on the inside of the block is abraded and delivered through the opening.

As actor all tools are conceivable, which can implement such a material abrasion. It is not substantial in this regard, whether, for example in the application of the invention to table salt, salt crystals are only detached or crystals are crushed by pushing movements. It is important that by simple movements, which can also be done manually, the material abrasion can be implemented without any further means, although powered drives can be used in connection with the invention.

In a special application of the invention the substance consists of a table salt body, which naturally comprises a firm surface such that this body can be gripped by the hand of a person without any difficulties. The actor in form of a rasp is inserted into the opening and the material abrasion is implemented for example by rotary movements.

The actor can also be provided with a source of light such that it can be better recognised, where material, which is translucent or transparent, is abraded; a battery powered LED is preferred in this regard.

It lies within the scope of the invention, to apply the actor such that it mainly abrades material from the outer area of the block. Above that, when the material block comprises a sufficiently large cavity, it can be used as a “lamp shade”, if it is sufficiently transparent.

The invention is explained below by way of example with reference to the drawings.

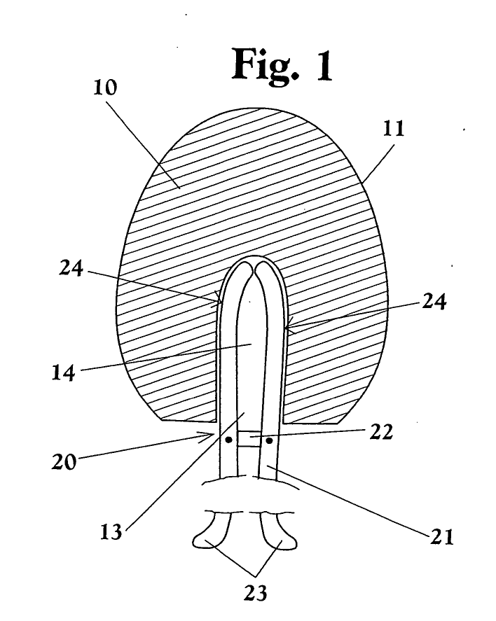

FIG. 1 shows a sectional view through the device according to the invention in the embodiment of a salt dispenser.

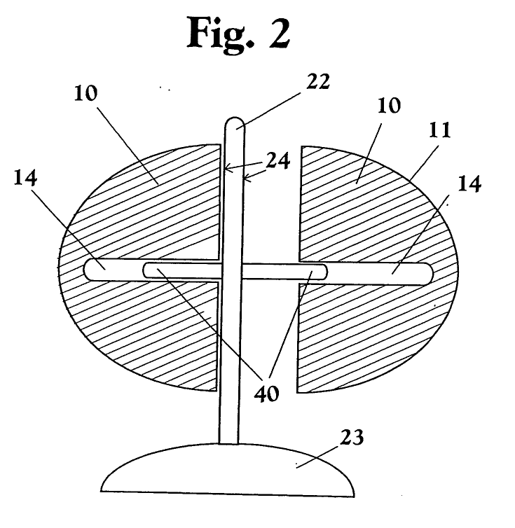

FIG. 2 shows a different embodiment of a salt dispenser according to the invention.

In FIG. 1, an egg-shaped block is indicated by 10, which consists of salt crystal and has obtained this egg shape through forming processes. 11 designates the outer surface, which is such firm and strong that the body 10 can be touched without any problem, while no salt crystals come off the block 10 thereby.

In the lower area the block 10 is designed flattened and comprises an opening indicated as 13.

In FIG. 1 the device according to the invention has been shown after a certain use, which can be recognised in that the opening 13 has been transformed into a more or less large cavity 14. In the cavity two rasp-like parts 21 of the actor 20 are shown. It is obvious, to use instead of two rasps 21 arranged opposite to each other three rasps spaced along the circumference or any larger number thereof. It is substantial that the rasps act inside of the block with their friction increasing surfaces 24 on the material of the block such that material is abraded there and can fall out downwards in the shown embodiment example. It is conceivable that the device is used in a position pivoted upwards by 180°, and is brought into the position shown in the figure only after the abrasion of material such that the abraded material can fall out downwards.

In the embodiment according to FIG. 2 corresponding parts are designated by the same reference numbers as in FIG. 1.

From the basis 23 a rasping disk projects, which is designed circularly, for example, and is provided on both sides with friction increasing surfaces 24.

Furthermore, two guide pins 40 project in the middle of the disk. These are inserted into the openings 14 of the salt crystal blocks 10.

The block 10 shown on the left-hand side is in its operational position, and when one grips it from the outside and turns the pin 14, material can be abraded from the base surface of the block 10.

The block 10 shown on the right-hand side is in a kind of preparatory position.

The rasping disk 24 can be provided with a kind of cover in the upper area in order to avoid injuries.

In the figures the two rasps are attached to each other through a part 22 and are formed at the bottom with a base 23, which can be used as a handle at the same time. By turning the handle 23 the rasps are put in rotation with their friction increasing surfaces 24 with regard to the block 10 such that material can be abraded in the desired manner and amount.

The rasps shown in the figures are only intended as an example for tools abrading material. It is possible within the scope of the invention to use wires as well, for example, with comprise diamond chips on their surface such that by suitable movements of such a wire the material abrasion can be achieved.

Finally it is also possible to implement the drive for the movement of the actor 20 through a different source of energy, that is to use a spring drive or an electric, battery powered drive.

1. Device for the metered delivery of small amounts of a substance, comprising a case for the substance and an outward leading opening for the delivery of the substance characterized in that the substance itself is formed as the case and has the shape of a block (10) with such a size that it can be at least partially gripped by the hand of a person or can be held in the hand, that the block is formed with a firm surface (11) on the outside and that an actor (20) is introducible and inserted through the opening (13) of the block, which releases and delivers desired amounts of the substances through rasping, pushing or friction engagement (24) with the inside of the block (10) and/or areas surrounding the opening.

2. Device according to claim 1, characterized in that the block (10) has the shape of a parallelepiped, a dice, a sphere or of an egg having dimensions in the range of some centimetres.

3. Device according to one the claims 1 or 2, characterized in that the actor is shaped as a grater, file, rasp or scraper, ram or a tool for removing material being introducible in the opening (13).

4. Device according to at least one of the claims 1 to 3, characterized in that the actor (20) has handles (23) outside of the block.

5. Device according to at least one the claims 1 to 4, characterized in that the actor (20) has feet (23) outside of the block.

6. Device according to at least one of the claims 1 to 5, characterized in that the substance is table salt and the block (10) is formed from a solid table salt body, which either has its natural shape or has been brought into a different desired shape (for example that of an egg.

7. Device according to at least one of the claims 1 to 6, characterized in that the actor (20) is provided with a source of light.

8. Device according to claims 1 or 2, characterized in that the source of light is a light-emitting-diode.
